(19) United States
(12) Patent Application Publication
(10) Pub. No.: US 2015/0081383 A1
(43) Pub. Date: Mar. 19, 2015

(54) GENERATING MULTIPLY CONSTRAINED GLOBALLY OPTIMIZED REQUESTS SUBJECT TO STATE OF ENVIRONMENT FOR PROPOSAL PACKAGES

(71) Applicant: International Business Machines Corporation, Armonk, NY (US)

(72) Inventors: Robert R. Friedlander, Southbury, CT (US); Richard Hennessy, Austin, TX (US); James R. Kraemer, Santa Fe, NM (US)

(73) Assignee: International Business Machines Corporation, Armonk, NY (US)

(21) Appl. No.: 14/030,264

(22) Filed: Sep. 18, 2013

(51) Int. Cl. G06Q 30/02; G06Q 30/08

(52) U.S. Cl. CPC G06Q 30/0202; G06Q 30/08
USPC 705/7.31

(57) ABSTRACT

A method, system and computer program product for determining an optimized set of sales events for a company. The method including the steps of determining a sales event is in an area supported by the company; extracting sales event parameters regarding the sales event; extracting data regarding a state of an environment surrounding a party offering the sales event; determining a probability of the extracted data regarding a state of the environment surrounding the party and assigning weights to the extracted data will affect the awarding of the sales event to the company; and based on the determined probabilities, mapping the sales event parameters to industry solution ontology based on the probabilities of extracted data of the state of the environment surrounding the party that will affect the sales event from being awarded to the company by the party.

### BACKGROUND

The present invention relates to sales strategies for optimizing requests in a response to an information request, proposal and/or statement of work, and more specifically to generating multiply constrained globally optimized requests subject to a state of environment for proposal packages.

Sales staff can have a difficult time determining whether the company they work for should put time and money towards responding to a sales event. A sales event is an occasion in which there is an opportunity to provide a response to a set problem or set of requirements to satisfy a client or customer. Often times, companies respond to any and all sales opportunities regardless of whether the company is in a position to “win” or be “awarded” the sale, resulting in wasted resources, missed opportunities to respond to other sales events, dissatisfied staff, underserving existing customers, or a negative perception of the company's ability to satisfy customer's requirements. The wasted resources can potentially impact client satisfaction due to the distraction of preparing the response to the sales event. The missed sales events that the company could have satisfied can result in lost revenue.

Sales staff of a company can overbid by responding to an inordinate number of sales events, causing the company to overextend it resources. This can detrimentally affect profitability by forcing the company to use outside resources to complete an awarded sale.

Additionally, the sales staff of a company may not take into account the state of the environment of the party awarding the sales event or the state of the environment of their own company responding to the sales event.

### SUMMARY

According to one embodiment of the present invention a method for determining an optimized set of sales events for a company. The method comprising the steps of: determining a sales event is in an area supported by the company; extracting sales event parameters regarding the sales event; extracting data regarding a state of an environment surrounding a party offering the sales event; determining a probability of the extracted data regarding a state of the environment surrounding the party and assigning weights to the extracted data will affect the awarding of the sales event to the company; and based on the determined probabilities, the sales event parameters are mapped to industry solution ontology based on the probabilities of extracted data of the state of the environment surrounding the party that will affect the sales event from being awarded to the company by the party.

According to another embodiment of the present invention, a computer program product for determining an optimized set of sales events for a company. The computer program product comprising: one or more computer-readable, tangible storage devices; and program instructions, stored on at least one of the one or more storage devices, to determine a sales event is in an area supported by the company; program instructions, stored on at least one of the one or more storage devices, to extract sales event parameters regarding the sales event; program instructions, stored on at least one of the one or more storage devices, to extract data regarding a state of an environment surrounding a party offering the sales event; program instructions, stored on at least one of the one or more storage devices, to determine a probability of the extracted data regarding a state of the environment surrounding the party and assigning weights to the extracted data will affect the awarding of the sales event to the company; and based on the determined probabilities, program instructions, stored on at least one of the one or more storage devices, to map the sales event parameters to industry solution ontology based on the probabilities of extracted data of the state of the environment surrounding the party that will affect the sales event from being awarded to the company by the party.

According to another embodiment of the present invention, a system for determining an optimized set of sales events for a company. The system comprising: one or more processors, one or more computer-readable memories and one or more computer-readable, tangible storage devices; and program instructions, stored on at least one of the one or more storage devices for execution by at least one of the one or more processors via at least one of the one or more memories, to determine a sales event is in an area supported by the company; program instructions, stored on at least one of the one or more storage devices for execution by at least one of the one or more processors via at least one of the one or more memories, to extract sales event parameters regarding the sales event; program instructions, stored on at least one of the one or more storage devices for execution by at least one of the one or more processors via at least one of the one or more memories, to extract data regarding a state of an environment surrounding a party offering the sales event; program instructions, stored on at least one of the one or more storage devices for execution by at least one of the one or more processors via at least one of the one or more memories, to determine a probability of the extracted data regarding a state of the environment surrounding the party and assigning weights to the extracted data will affect the awarding of the sales event to the company; and based on the determined probabilities, program instructions, stored on at least one of the one or more storage devices for execution by at least one of the one or more processors via at least one of the one or more memories, to map the sales event parameters to industry solution ontology based on the probabilities of extracted data of the state of the environment surrounding the party that will affect the sales event from being awarded to the company by the party.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a schematic of an overview of the system for generating global optimized strategies to determine a response to a sales event which may include information requests, proposals, and statements of work, within a time period with information which spans across hierarchical entity boundaries.

FIG. 3 shows a schematic of a system for finding and organizing requirements, resources and responses for use during optimization routines in the system of FIG. 2.

FIG. 4 shows a schematic of a system for finding and organizing routes associated with responses for use during optimization routines in the system of FIG. 2.

FIG. 5 shows a schematic of a system for predicting the likelihood of being awarded the sales event for use during optimization routines in the system of FIG. 2.

FIGS. 6-7 show a flowchart of a method for generating global optimized strategies to determine a response to an information request, proposal, or statement of work with information which spans across hierarchical entity boundaries, and to optimize responses to requests subject to uncertainty across multiple time horizons.

FIG. 8 shows a flowchart of a method of initiating sales resource optimization to determine an optimized resource package to present in response to a sales event that considers the state of the environment of at least the party providing the sales event.

FIG. 9 illustrates internal and external components of a client computer and a server computer in which illustrative embodiments may be implemented.

### DETAILED DESCRIPTION

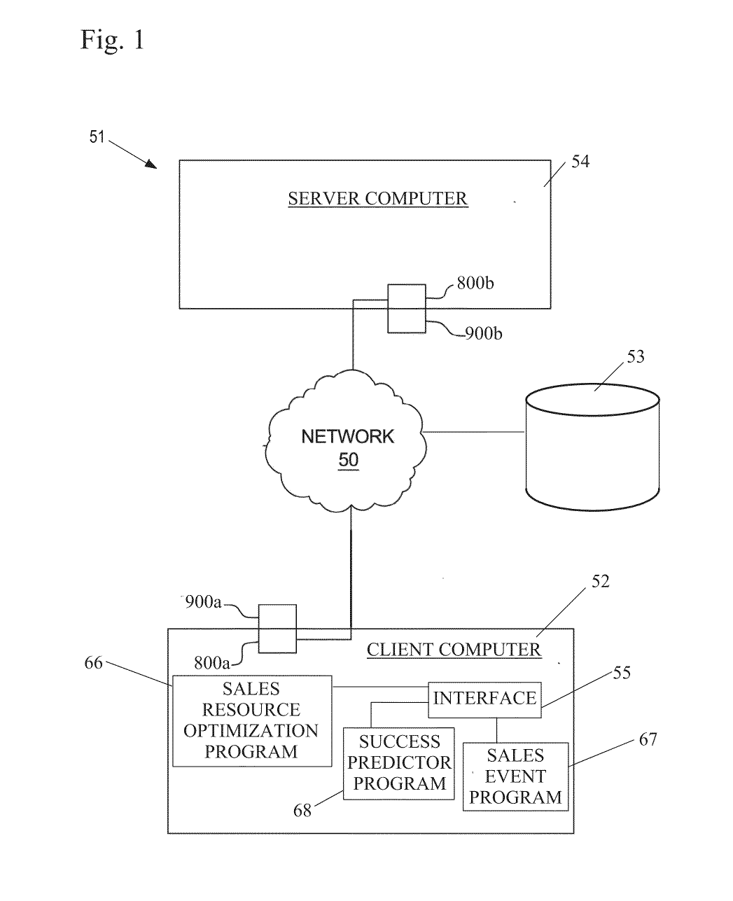

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

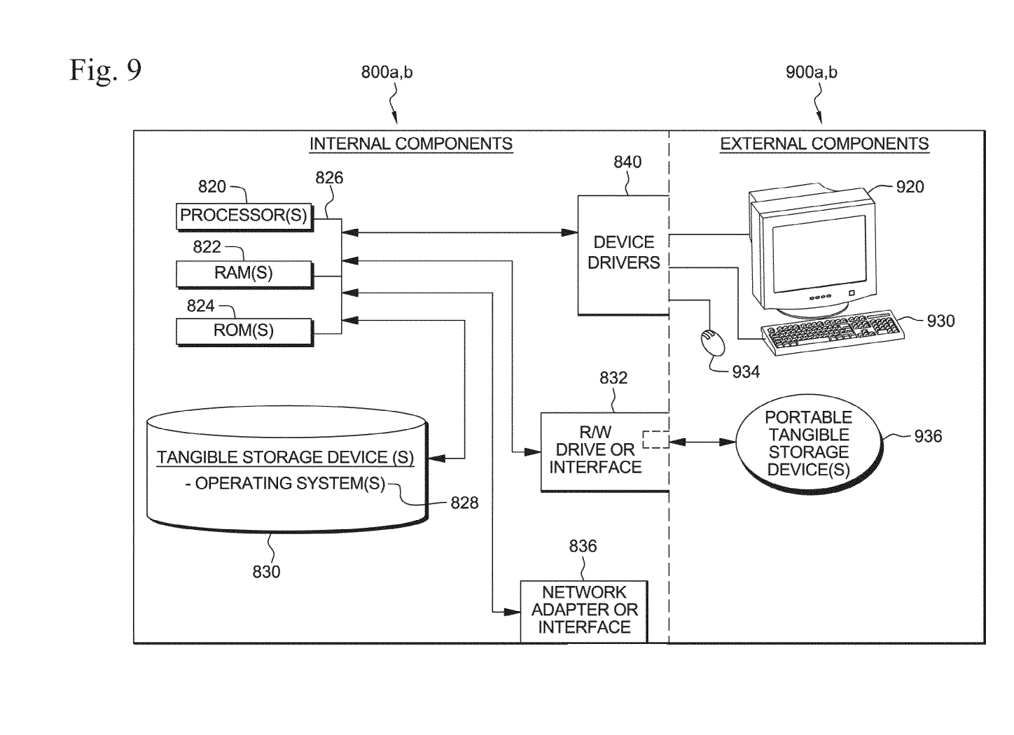

In the depicted example, a client computer 52, server computer 54, and a repository 53 connect to network 50. In other exemplary embodiments, network data processing system 51 may include additional client computers, storage devices, server computers, and other devices not shown. The client computer 52 includes a set of internal components 800a and a set of external components 900a, further illustrated in FIG. 9. The client computer 52 may be, for example, a mobile device, a cell phone, a personal digital assistant, a netbook, a laptop computer, a tablet computer, a desktop computer, a sequencing machine or any other type of computing device.

Client computer 52 may contain an interface 55. The interface can be, for example, a command line interface, a graphical user interface (GUI), or a web user interface (WUI). The interface may be used, for example for viewing resources, resource skills, sales resource optimization packages, predictability statistics, mapping of resources to industry solution ontology, and sales events. The interface may also accept an input regarding a predetermined predictability statistic, or information which aids in the generation of the sales resource optimization package.

In the depicted example, server computer 54 provides information, such as boot files, operating system images, and applications to client computer 52. Server computer 54 can compute the information locally or extract the information from other computers on network 50. Server computer 54 includes a set of internal components 800b and a set of external components 900b illustrated in FIG. 9.

Program code and programs such as a sales event program 67, a sales resource optimization program 66, and a success predictor program 68 may be stored on at least one of one or more computer-readable tangible storage devices 830 shown in FIG. 9, on at least one of one or more portable computer-readable tangible storage devices 936 as shown in FIG. 9, or repository 53 connected to network 50, or downloaded to a data processing system or other device for use. For example, program code, a sales event program 67, a sales resource optimization program 66, and a success predictor program 68 may be stored on at least one of one or more tangible storage devices 830 on server computer 54 and downloaded to client computer 52 over network 50 for use on client computer 52. Alternatively, server computer 54 can be a web server, and the program code, a sales event program 67, a sales resource optimization program 66, and a success predictor program 68 may be stored on at least one of the one or more tangible storage devices 830 on server computer 54 and accessed on client computer 52. Sales event program 67, sales resource optimization program 66, and success predictor program 68 can be accessed on client computer 52 through interface 55. In other exemplary embodiments, the program code and programs such as a sales event program 67, a sales resource optimization program 66, and a success predictor program 68 may be stored on at least one of one or more computer-readable tangible storage devices 830 on client computer 52 or distributed between two or more servers.

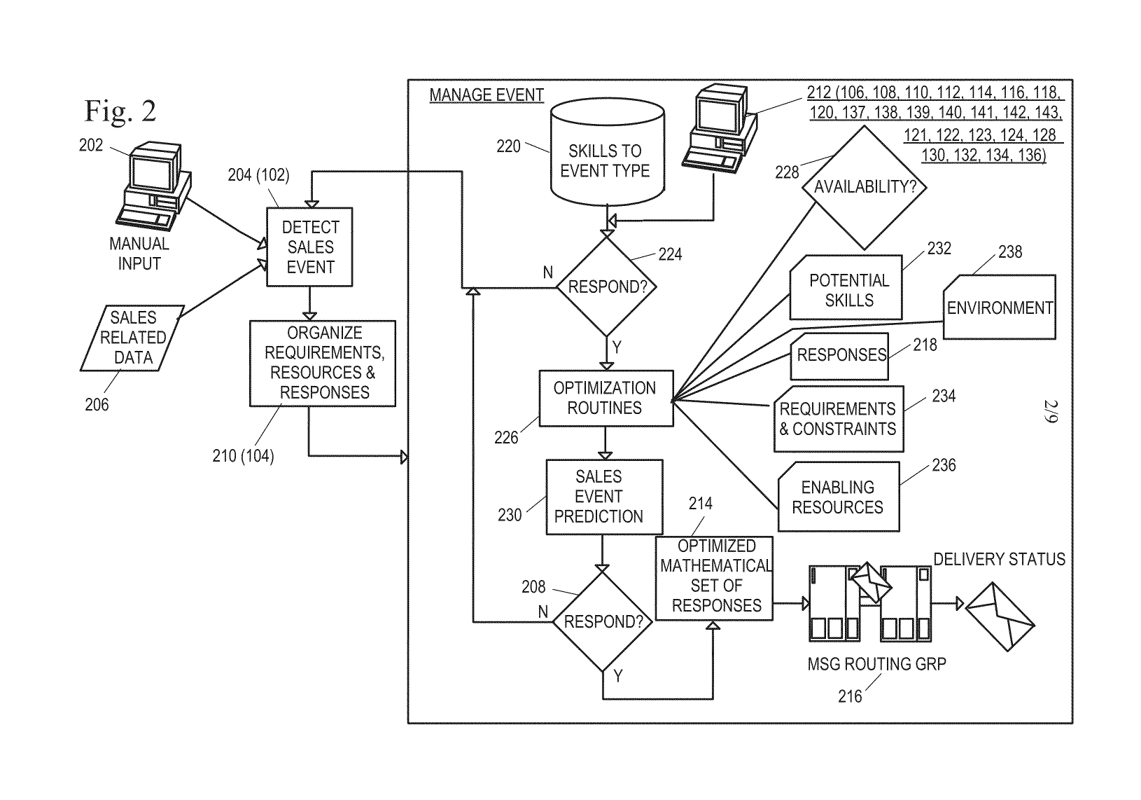

FIG. 2 shows a high level overview of a system for generating global optimized strategies for information requests, proposals, and statements of work within a time period across hierarchical entity boundaries. A sales event is an occasion in which there is an opportunity to provide a response to a set of problems or set of requirements to satisfy a client or customer. The sales event is usually open to receiving responses for a short period of time.

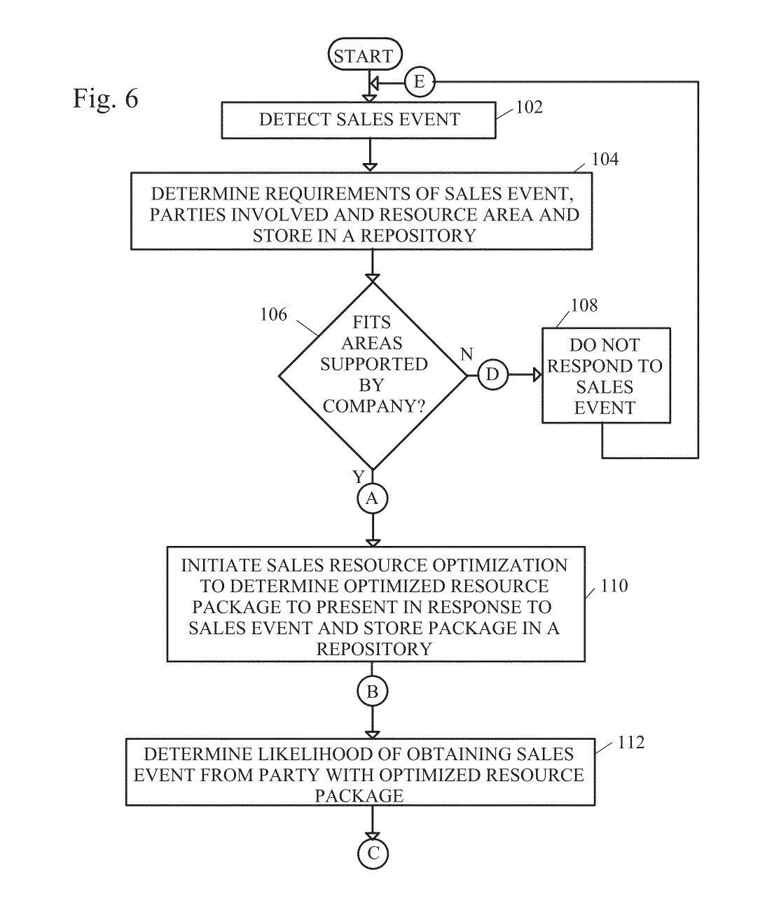

FIGS. 6-8 show a flowchart, to which the numbered steps below refer.

A sales event is detected 204 (step 102) from manual input 202 and/or sales related data 206 that may be monitored. The requirements, resources and previous responses to the sales event are organized 210 (step 104) and the sales event is then managed 212 (steps 106, 108, 110, 112, 114, 116, 118, 120, 121, 122, 123, 124, 128, 130, 132, 134, 136, 137, 138, 139, 140, 141, 142, 143) to determine in a response should be made to the sales event and if so, what response.

The management of the sales event 212 includes a first decision 224 whether to respond to the sales event based on the area or event type of the sales event within input from a repository of a company's skills in a specific area 220 as well as any manual input 202. If a first decision 224 is made not to respond, the system returns to detecting sales events 204.

If a decision is made to respond, optimization routines 226 are run taking into account potential skills 232, requirements and constraints 234, enabling resources 236, availability of skills and resources 228, past or present responses 218, and environment 238. The environment 238 may be just the state of the environment surrounding the party awarding the sales event. Alternatively and in a preferred embodiment, a state of the environment of the company responding to the sales event is also considered with the state of the environment of the party awarding the sales event.

“Environment” as used herein is defined as the circumstances or conditions surrounding a company or party. For example, the environment might include the global economy, buying strategy of the company or party, state of the market in which the company or party are in, financial situation of the company or party, turnover rate of the company or party, expected competitor actions if the company responds to the sales event, expected competitor actions if the sales event is awarded to the company by the party, and economic trends involving the company or party.

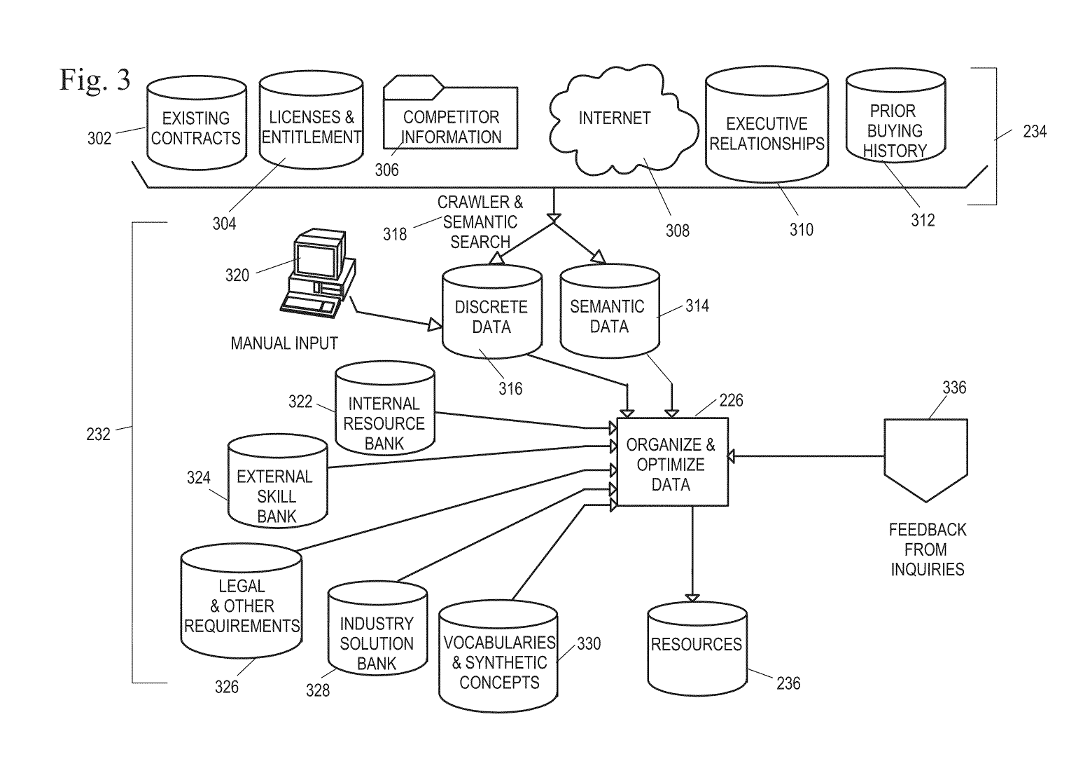

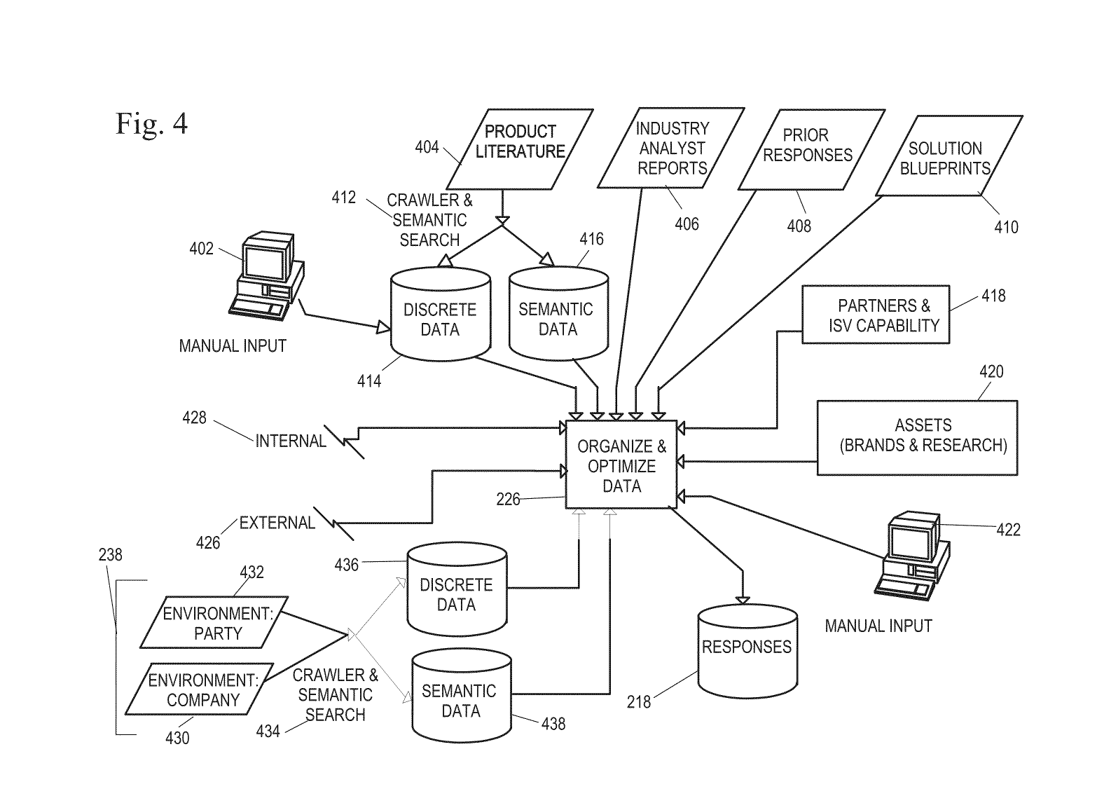

The generation of the enabling resources 236 is shown in FIG. 3. During the optimization routines 226, a response 218 that may be part of an optimized resource package is produced. The data that may be used to aid in generating responses 218 are shown in FIG. 4, including environment data 238.

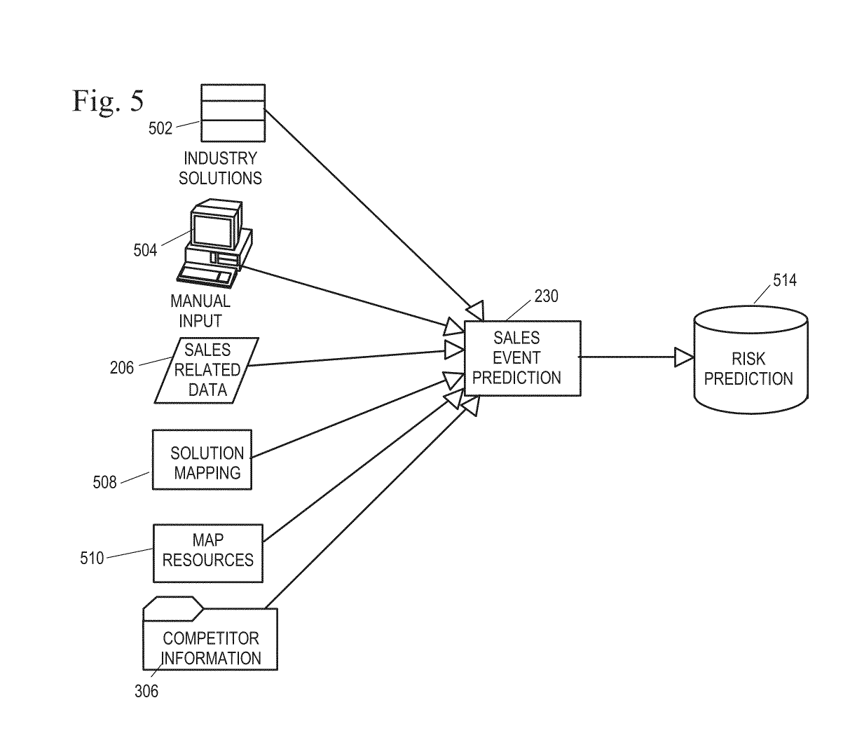

The sales event prediction system is shown in FIG. 5. This prediction 230 aids in determining 208 whether a response is necessary to the sales event. If the prediction indicates that there is a low probability that the company will be awarded the sale, the system returns to monitoring sales events 204.

If the prediction indicates that there is a high probability that the company will be awarded the sale based on the sales event, an optimized mathematical set of sales events and associated resource packages is generated, taking into account penalties and costs to profitability. The optimized mathematical set of resource packages is sent onto a message group 216 to appropriately handle responding to the sales event. Any feedback from a message group will update the system, including organization of the requirements, resources and responses 210 and how the sales events are managed 212.

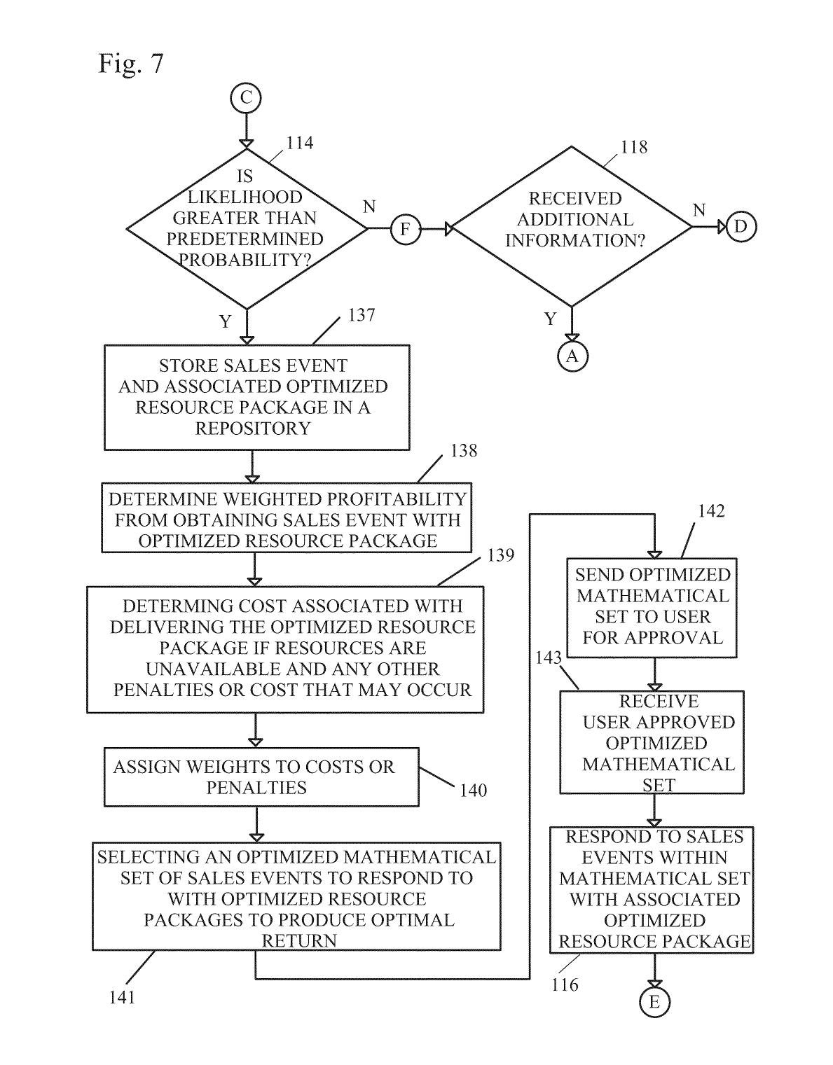

FIGS. 6-7 show a flowchart of a method for generating global optimized strategies to determine a response to an information request, proposal, or statement of work with information which spans across hierarchical entity boundaries, and to optimize responses to requests subject to uncertainty across multiple time horizons.

In a first step, a sales event is detected (step 102).

Next, requirements of the sales event, parties involved and resource area of the sales event are stored in a repository (step 104), for example by the sales event program 67. The sales event parameters, constraints and other information may be extracted by using advanced text analytics (ICPA) against known collateral sources.

The known collateral sources may include, but are not limited to, product specifications, prior requests for proposals, statements of work, the company's deliverables, the company's service assets, and research assets. The collateral sources may also include external information from the company, and can include state and government information, for example from government requests for proposals and government requests for information. The collateral sources may be further expanded by the base knowledge of what resources and partners of the company supply.

The sales event constraints may include, but are not limited to, factors such as: client budget; previous buying behavior; competitor price point; competitor functionality; client account relationships, such as sponsorships; profit percentage or margin on other similar opportunities in the industry; degree of uplift on the margin required; resource availability; and legal requirements of the response, which can include non-compete requirements, jurisdiction licensing, warranties, indemnities, etc. The requirements may include the logistics of presenting a response to the sales event.

If the resource area of the sales event does not fit into an area which is supported by the company (step 106), the sales event is not responded to by the company (step 108) and the method returns to step 102 of detecting a sales event.

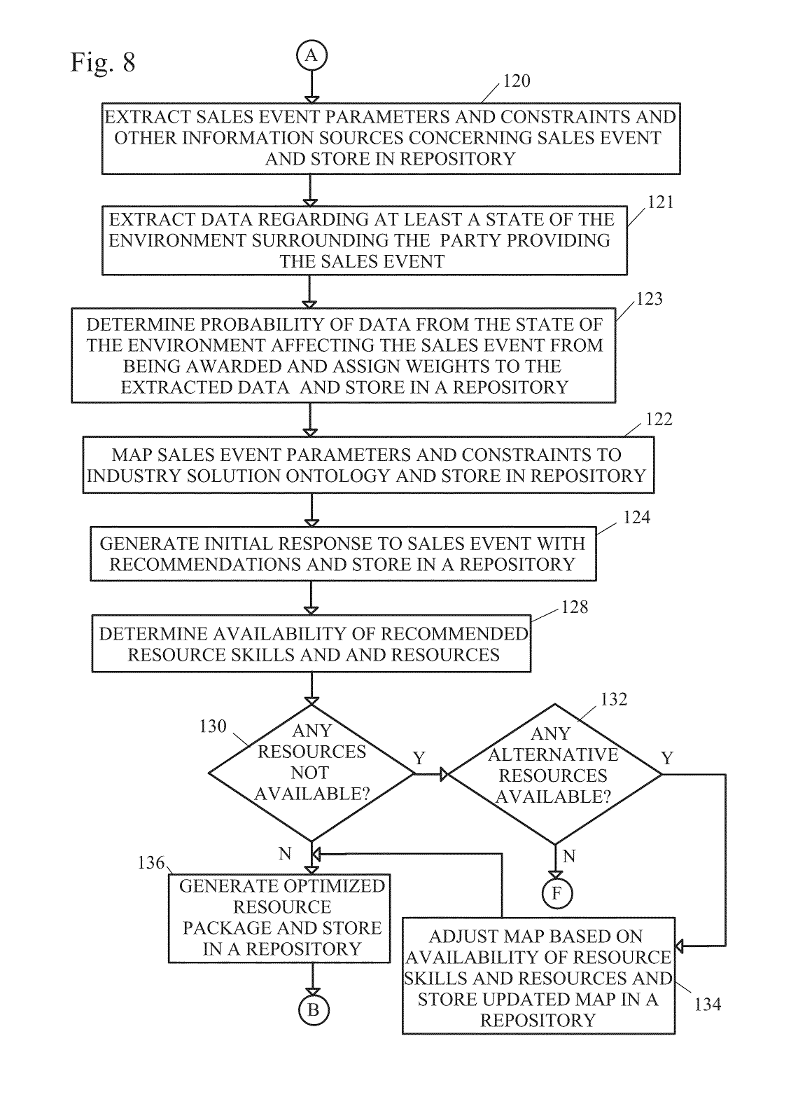

If the resource area of the sales event does fit into an area which is supported by the company (step 106), sales resource optimization is initiated to determine an optimized resource package to present in response to the sales event (step 110), for example by the sales resource optimization program 66. The optimized resource package determined in step 110 is stored in a repository, for example repository 53 of FIG. 1. The determination of an optimized resource package in step 110 to present in response to the sales event based on available resources of the company is determined through steps 120-136, shown in FIG. 8.

A likelihood of obtaining, winning, or being awarded the sale from the party is determined using the optimized resource package (step 112), for example by the success predictor program 68.

If the likelihood of being awarded the sale is not greater than a predetermined probability (step 114), and no additional information that might alter the optimized resource package has been received (step 118), then the sales event is not responded to by the company (step 108) and the method returns to step 102 of detecting a sales event.

If additional information has been received (step 118), the method returns to step 110 of initiating sales resource optimization.

If the likelihood of being awarded the sale based on the sales event is greater than a predetermined probability (step 114), then the sales event and the associated optimized resource package is stored in a repository (step 137), for example repository 53.

For each stored sales event and associated optimized resource package, the weighted profitability of obtaining or being granted the sale is determined using the optimized resource package (step 138).

The weighted profitability takes into account the cost of the optimized resource package relative to the payoff, monies, or benefits expected to be received for completion of the sales event as determined by the sales event parameters. The weighted profitability for each stored sales event and associated optimized resource package is stored in a repository, for example repository 53. The weighted profitability may be determined by the success predictor program 68.

It should be noted that step 138 may be implemented when a single sales event and associated optimized resource package is stored in the repository, or when multiple sales events and associated optimized resource packages are stored.

The cost is then determined for delivering the same optimized resource package for an associated sales event, if the resources within the optimized resource package were unavailable to the company for use with such associated sales event because of their use with the present sale, as well as any other penalties or costs that may occur (step 139). The cost may be determined for example, by the success predictor program 68.

It should be noted that the success predictor program 68 may use a predetermined set of penalties, for example for lack of completion, a percentage of resources of the optimized resource package available for use, or other penalties and costs associated with a cost to the company, such as retracting the optimized resource package from the bidding of the sales event within a certain time frame; failing to fulfill all of the parameters of the sales event; underbidding a total number of sales events within a specific time frame; overbidding a total number of sales event within a specific time frame; removal of highly demanded resources from the pool of resources available for additional resource packages; and alienation of other companies based on acceptance of a sales event for a specific company. Alternatively, a user may indicate specific penalties or costs for use in this step, for example through the interface 55 to the success predictor program 68.

Weights are received from a user and assigned to the costs or penalties of step 139 or alternatively historical averages or predetermined weights are used (step 140).

An optimized mathematical set of sales events are selected for response with the associated optimized resource packages to produce an optimal return (step 141), for example with the success predictor program 68. The optimized mathematical set is stored in a repository, for example repository 53 of FIG. 1. The optimized mathematical set of sales events are selected, for example using equation (1.1) to maximize probable profitability, subject to equation (1.1), of resource constriction below:

$$Maximize {\sum }_{j = 1}^{n} {X}_{j} \cdot {M}_{j} \cdot {P}_{j} \\ Subject to {\sum }_{i = 1}^{n} {\sum }_{k = 1}^{r} {X}_{j} \cdot {R}_{i , k} \cdot {P}_{j} \leq {T}_{j} \qquad ( 1.1 )$$

Where:
n=number of possible sales events that fit areas supported by the company;
i, j=index number
r=number of limited resources
Xⱼ, an element, for example binary sales event selection variable, is defined by the formula:

Xⱼ=ε{0,1}
Mⱼ, the margin for j^{th} sales event, is determined by the formula:

Mⱼ=Revenueⱼ−Costⱼ
Costⱼ is determined by the formula:

$${Cost}_{j} = {\sum }_{q = 1}^{r} {Price}_{q} \cdot {R}_{q , j}$$

Price_{q}=price of q^{th} resource
R_{q,j}=amount of q^{th} resource needed by j^{th} sales event
Pⱼ=probability of winning j^{th} sales event
Tⱼ=Total amount of jth resource available for all projects

In a simplistic example there are five sales events as shown in Tables 1-3 below.

TABLE 1

| | Sales | Sales | Sales | Sales | Sales | |
|---|---|---|---|---|---|---|
| | Event 1 | Event 2 | Event 3 | Event 4 | Event 5 | |
| Binary | 1 | 0 | 1 | 0 | 1 | |
| Selection | | | | | | |
| Variable | | | | | | |
| Sales | 10 | 60 | 40 | 70 | 90 | |
| Event | | | | | | |
| Payout | | | | | | |
| Expected | 10 | 0 | 40 | 0 | 90 | Sum of the |
| Profit | | | | | | objective |
| | | | | | | function = 140 |

TABLE 2

| | | | | | | Available |
|---|---|---|---|---|---|---|
| Project | | | | | | inputs |
| Required | Sales | Sales | Sales | Sales | Sales | from |
| Inputs | Event 1 | Event 2 | Event 3 | Event 4 | Event 5 | Company X |
| Business | 1 | 5 | 3 | 5 | 8 | 12 |
| Analysts | | | | | | |
| Data Miners | 0 | 1 | 1 | 2 | 2 | 4 |
| Programmers | 2 | 6 | 4 | 8 | 14 | 22 |

TABLE 3

| | | | | | | Total for |
|---|---|---|---|---|---|---|
| | | | | | | Each |
| Utilized | Sales | Sales | Sales | Sales | Sales | Resource |
| Inputs | Event 1 | Event 2 | Event 3 | Event 4 | Event 5 | Type |
| Business | 1 | 0 | 3 | 0 | 8 | 12 |
| Analysts | | | | | | |
| Data Miners | 0 | 0 | 1 | 0 | 2 | 3 |
| Programmers | 2 | 0 | 4 | 0 | 14 | 20 |

Each of the sales events in Table 1 provides varying payout or monies paid. The profit for Company X from responding to the sales events is maximized subject to the limiting resources in order to produce an optimized mathematical set of sales events that will maximize the company's profit. Referring to Table 1, there are five sales events with sales event payout and expected profit for the company.

For each sales event, certain requirements are needed. In this example, the requirements are limited to the resources of business analysts, data miners and programmers. Company X only has 12 business analysts, 4 data miners and 22 programmers available. If Company X were to respond to all of the sales events, 22 business analysts, 6 data miners and 34 programmers would be needed as shown in Table 2.

While not shown in this example, the specific costs and penalties associated with hiring additional data miners, business analysts, and programmers to fulfill all of the sales events would be determined and factored in. In this example it was assumed to be too costly for Company X and hire all of the resources it would need to respond to all of the sales events.

This cost and penalty would result in zero expected profit as shown in Table 1. After using equation 1.1, the optimized mathematical set that would yield that most profit for Company X would be sales event 1, sales event 3 and sales event 5, resulting in an expected profit of 140 and using all of the business analysts, all but one data miner, and all but two of the programmers.

The optimized mathematical set of sales events to be followed up, optimized against uncertainty across multiple time horizons, is sent to a user for approval (step 142). The user may be a user within the management of the company.

The user can determine whether the optimized mathematical set of sales event contains any anomalies or errors, for example, where a bid could damage current relationships of the company. If an anomaly is present, the user would manually remove the sales event from the repository and redo steps 138-142.

An approved mathematical set is received from a user (step 143), and based on the approved mathematical set from the user, the sales events within the mathematical set are responded to with the associated optimized resource packages (step 116), and then the method returns to step 102 of detecting a sales event. Step 143 may be performed by the sales event program 67.

By determining an optimized mathematical set, the problems associated with not bidding enough to generate needed revenue and the problems of bidding and being awarded too many sales in multiple time periods or horizons are taken into account and removed from the sales event response process for the company. The optimized mathematical set also accounts for the amount of money needed to fund any alternative resources to staff the sales event through the objective function.

FIG. 5 shows a schematic of a system for predicting the likelihood of winning the sales event 230, which takes place within the management of the sales event 212 and corresponds to steps 112 and 114 of FIGS. 6-7. A sales event prediction 230 outputs a risk prediction 514, in other words, the chances of winning or being awarded the sales event by receiving and considering input regarding industry solutions 502, manual input 504, sales related data 206, solution mapping 508, resource mapping 510, and competitor information 306.

Referring to FIG. 8, sales event parameters, constraints and other information sources concerning the sales event are extracted, for example by the sales resource optimization program 66, and stored in a repository (step 120).

FIG. 3 shows a schematic of a system for finding and organizing requirements, resources and responses that take part in the optimization routines 226 of FIG. 2 and for step 120. Requirements and constraints 234 of the sales event and the company are searched in a crawler or semantic search 318. The requirements and constraints may be found in data repositories of existing contracts 302, licenses and entitlement 304, competitor information 306, other information mined from the Internet 308, executive relationships 310, and prior buying history 312.

The results of the crawler or semantic search 318, which mines the repositories of data, are divided into a repository of discrete data 316 and semantic data 314. Manual input 320 of additional data may be stored in the discrete data repository 316.

The discrete data 316 and the semantic data 314 provide input to an organization of data process which is part of the optimization routine 226. Additionally, the organization of data process which is part of the optimization routine 226 may also receive input from potential skills of a company, which can be found in data repositories of an internal resource bank 322, an external skill bank 324, legal and other requirements 326, an industry solution bank 328, vocabularies and synthetic concepts 330, and feedback from any inquiries, past or present 336. The organization of data process of the optimization routine 226 outputs the enabling resources 236 that are required to manage or respond to the sales event.

Data regarding at least a state of the environment surrounding the party providing or awarding the sales event is extracted and stored in a repository (step 121), for example by the sales event program 67. The repository may be repository 53 of FIG. 1. The state of the environment surrounding the company which is determining whether to respond to the sales event, may also be extracted or obtained as well.

From the data extracted and stored in the repository, the probability of the data affecting the sales event being awarded to the company by the party is determined and weights are assigned to the data and stored in a repository (step 123), for example by the sales event program 67. The data affecting the sales event may include, but is not limited to the probability of a recession starting, probability of a competitor may announce a superior project, probability that a critical employee may leave the company for a competitor. The weights may be assigned manually by a user through an interface, or may be a predetermined set of weights. The predetermined set may be at least partially based on historical averages, trends, predictive analytics, machine learning, manual input, or other types of algorithms. The probability may be determined, for example, using equation (1.2) below:

Pⱼ=Probability(Aⱼ|Bⱼ) (1.2)

Where:

$$Probability ( {A}_{j} \vert {B}_{j} ) = \frac{Probability ( {B}_{j} \vert {A}_{j} ) * Probability ( {A}_{j} )}{Probability ( {B}_{j} )}$$

Aⱼ=probability of success for sales event j

Bⱼ=probability of an impinging factor may affect the impending sales event j

The sales event parameters and constraints are mapped to industry solution ontology based on the probabilities of the data affecting the sales event being awarded to the company by the party and stored in a repository (step 122). Client deliverables, such as work products, project plans, solution blueprints, product literature, etc., are incorporated into the system to support continuous optimization of the sales resource package and build a knowledge model of the industry.

FIG. 4 shows a schematic of a system for finding and organizing responses, which take part in the optimization routines 226 of FIG. 2 and for steps 121, 122 and 123, within the management of the event 212.

A crawler or semantic search 412 may take place to mine product literature 404 and divides the results into a repository of discrete data 414 and semantic data 416. Manual input 402 of additional data may be stored in the discrete data repository 414.

The discrete data 414 and the semantic data 416 provide input to an organization of data process 210 that take part in the optimization routines 226. Additionally, the organization of data process 210, that take part in the optimization routines 226 may also receive input from industry analyst reports 406, prior responses 408, solution blueprints 410, partners and independent software vendor capabilities 418, assets 420 including brands and research, manual input 422, internal 428 or external 426 communication or other sources of information.

The organization of data process 210, that take part in the optimization routines 226, outputs responses 218 that are required to manage or respond to the sales event.

A crawler or semantic search 434 may take place to mine the environment of the company 430 and the environment of the party 432 and divide the results into a repository of discrete data 436 and semantic data 438. Manual input 422 of the weights may also be used.

The discrete data and semantic data provides input regarding the state of the environment surrounding a company or party and lends important incites regarding how the resource package should be optimized and tailored.

For example, a company during a recession would not offer an expensive, top of the line brand product for a sales event to a party that is struggling, for example due to a stock market downturn for the value of a resource the party deals heavily with and needs to operate.

In another example, if the company has information that lends to a high probability that a competitor will reduce their price for a sales event, the company may reduce or change the resources within the optimized package or alter the optimized package.

Without knowing any data regarding at least a state of environment of the party, considerations and modifications to adjust the optimized resource package would not be made and may adversely affect a probability of being awarded the sales event.

The knowledge model may be used to impact solutions and product blueprints, such that functionality roadmaps based on this knowledge and state of the environment can be prioritized, to impact sales staffing and training programs based on trends within the market, to improve automation of sales response based on what is working, identification of processes that can be streamlined, and to identify gaps in a company's portfolio.

An initial response to the sales event based on steps 120 and 122 is generated and stored in a repository (step 124). By cataloging or extracting the parameters, constraints, requirements and other information from a sales event, and matching these parameters, constraints, requirements to known capabilities of a company, a high level or initial solution response to the sales event can be generated.

The initial solution response also includes a recommended preference with associated resource requirements including an order or magnitude and a monetary estimate to complete and provide the solution. The monetary estimate can also include a margin of error and an estimated monetary amount for additional components required to complete the solution.

The recommendations may include high level architecture, company business value proposition, software and hardware recommendations with initial sizing and pricing leverage, high level optimal work breakdown structure, intellectual property, resource spanning patterns, and other identifiers that would distinguish the company from other competitors and their responses to the sales event. The identifiers may be key contacts, asset availability, price point, infrastructure, resources, etc. . . . .

The company business value proposition may be based on return on investment, paybacks, net present value, and product specifications from prior related activities. The resource spanning patterns can include solution strategies, solution designs, implementation, testing, and on-going support. Furthermore, the recommendations consider existing company activities that may be leveraged.

The availability of recommended resources and resource skills from step 126 are determined (step 128). If there are resource or resource skills that are not available (step 130), and there aren't any alternative resources available to substitute (step 132), and no additional information received (step 118), then the sales event is not responded to by the company (step 108) and the method returns to step 102 of detecting a sales event.

If there are resource or resource skills that are not available (step 130), and there are alternative resources available to substitute (step 132), the map is adjusted based and stored in a repository (step 134). The method continues with step 136.

If the resources and resource skills are all available (step 130), the optimized resource package is generated (step 136).

FIG. 9 illustrates internal and external components of client computer 52 and server computer 54 in which illustrative embodiments may be implemented. In FIG. 9, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, a sales event program 67, a sales resource optimization program 66, and a success predictor program 68 are stored on one or more of the computer-readable tangible storage devices 830 for execution by one or more of the processors 820 via one or more of the RAMs 822 (which typically include cache memory). In the embodiment illustrated in FIG. 9, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A sales event program 67, a sales resource optimization program 66, and a success predictor program 68 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Sales event program 67, sales resource optimization program 66, and success predictor program 68 can be downloaded to client computer 52 and server computer 54 from an external computer via a network (for example, the Internet, a local area network or other, wide area network) and network adapter or interface 836. From the network adapter or interface 836, a sales event program 67, a sales resource optimization program 66, and a success predictor program 68 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Sales event program 67, sales resource optimization program 66, and success predictor program 68 can be written in various programming languages including low-level, high-level, object-oriented or non object-oriented languages. Alternatively, the functions of a sales event program 67, a sales resource optimization program 66, and a success predictor program 68 can be implemented in whole or in part by computer circuits and other hardware (not shown).

Based on the foregoing, a computer system, method and program product have been disclosed to determine an optimized set of a sales event for a company. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining an optimized set of sales events for a company, comprising the steps of:
determining a sales event is in an area supported by the company;
extracting sales event parameters regarding the sales event;
extracting data regarding a state of an environment surrounding a party offering the sales event;
determining a probability of the extracted data regarding a state of the environment surrounding the party and assigning weights to the extracted data will affect the awarding of the sales event to the company; and
based on the determined probabilities, the sales event parameters are mapped to industry solution ontology based on the probabilities of extracted data of the state of the environment surrounding the party that will affect the sales event from being awarded to the company by the party.

2. The method of claim 1, wherein the step of extracting data regarding the state of the environment surrounding a party offering the sales event further comprises extracting data regarding an environment surrounding the company.

3. The method of claim 1, wherein the probability is determined by:
Pⱼ=Probability(Aⱼ|Bⱼ)
Where:
$$Probability ( {A}_{j} \vert {B}_{j} ) = \frac{Probability ( {B}_{j} \vert {A}_{j} ) * Probability ( {A}_{j} )}{Probability ( {B}_{j} )}$$
Aⱼ=probability of success for sales event j
Bⱼ=probability of an impinging factor may affect the impending sales event j.

4. A computer program product for determining an optimized set of sales events for a company, the computer program product comprising:
one or more computer-readable, tangible storage devices;
program instructions, stored on at least one of the one or more storage devices, to determine a sales event is in an area supported by the company;
program instructions, stored on at least one of the one or more storage devices, to extract sales event parameters regarding the sales event;
program instructions, stored on at least one of the one or more storage devices, to extract data regarding a state of an environment surrounding a party offering the sales event;
program instructions, stored on at least one of the one or more storage devices, to determine a probability of the extracted data regarding a state of the environment surrounding the party and assigning weights to the extracted data will affect the awarding of the sales event to the company; and
based on the determined probabilities, program instructions, stored on at least one of the one or more storage devices, to map the sales event parameters to industry solution ontology based on the probabilities of extracted data of the state of the environment surrounding the party that will affect the sales event from being awarded to the company by the party.

5. The computer program product of claim 4, wherein the program instructions, stored on at least one of the one or more storage devices, to extract data regarding the state of the environment surrounding a party offering the sales event further comprises program instructions, stored on at least one of the one or more storage devices, to extract data regarding an environment surrounding the company.

6. The computer program product of claim 4, wherein the probability is determined by:
Pⱼ=Probability(Aⱼ|Bⱼ)
Where:
$$Probability ( {A}_{j} \vert {B}_{j} ) = \frac{Probability ( {B}_{j} \vert {A}_{j} ) * Probability ( {A}_{j} )}{Probability ( {B}_{j} )}$$
Aⱼ=probability of success for sales event j
Bⱼ=probability of an impinging factor may affect the impending sales event j.

7. A system for determining an optimized set of sales events for a company, the system comprising:
one or more processors, one or more computer-readable memories and one or more computer-readable, tangible storage devices;
program instructions, stored on at least one of the one or more storage devices for execution by at least one of the one or more processors via at least one of the one or more memories, to determine a sales event is in an area supported by the company;
program instructions, stored on at least one of the one or more storage devices for execution by at least one of the one or more processors via at least one of the one or more memories, to extract sales event parameters regarding the sales event;
program instructions, stored on at least one of the one or more storage devices for execution by at least one of the one or more processors via at least one of the one or more memories, to extract data regarding a state of an environment surrounding a party offering the sales event;
program instructions, stored on at least one of the one or more storage devices for execution by at least one of the one or more processors via at least one of the one or more memories, to determine a probability of the extracted data regarding a state of the environment surrounding the party and assigning weights to the extracted data will affect the awarding of the sales event to the company; and
based on the determined probabilities, program instructions, stored on at least one of the one or more storage devices for execution by at least one of the one or more processors via at least one of the one or more memories, to map the sales event parameters to industry solution ontology based on the probabilities of extracted data of the state of the environment surrounding the party that will affect the sales event from being awarded to the company by the party.

8. The system of claim 7, wherein the program instructions, stored on at least one of the one or more storage devices for execution by at least one of the one or more processors via at least one of the one or more memories, to extract data regarding the state of the environment surrounding a party offering the sales event further comprises program instructions, stored on at least one of the one or more storage devices for execution by at least one of the one or more processors via at least one of the one or more memories, to extract data regarding an environment surrounding the company.

9. The system of claim 7, wherein the probability is determined by:
Pⱼ=Probability(Aⱼ|Bⱼ)
Where:
$$Probability ( {A}_{j} \vert {B}_{j} ) = \frac{Probability ( {B}_{j} \vert {A}_{j} ) * Probability ( {A}_{j} )}{Probability ( {B}_{j} )}$$
Aⱼ=probability of success for sales event j
Bⱼ=probability of an impinging factor may affect the impending sales event j.
